(19) United States
(12) Patent Application Publication
(10) Pub. No.: US 2005/0139240 A1
(43) Pub. Date: Jun. 30, 2005

(54) Rinsing and drying apparatus having rotatable nozzles and methods of rinsing and drying semiconductor wafers using the same

(76) Inventors: Woon-Geun Bong, Hwaseong-gun (KR); Seung-Kun Lee, Suwon-si (KR); Man-Young Lee, Hwaseong-gun (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/002,624

(22) Filed: Dec. 3, 2004

(30) Foreign Application Priority Data
Dec. 29, 2003 (KR) 2003-99117

(51) Int. Cl. B08B 3/02

(52) U.S. Cl. 134/34; 134/176; 134/179; 134/102.3; 134/95.2; 134/36; 134/186

(57) ABSTRACT

Rinsing and drying apparatus having rotatable drying source nozzles and methods of rinsing and drying semiconductor wafers are provided. The apparatus includes a bath for storing liquid and rotatable nozzles disposed over the bath. The semiconductor wafers are rinsed using de-ionized water inside the bath. After the rinsing process, de-ionized water is drained. A drying source is then sprayed onto the semiconductor wafers through the rotatable nozzles. The nozzles are oscillated and/or rotated while the drying source is sprayed.

### BACKGROUND OF THE INVENTION

1. Technical Field

The present invention generally relates to equipment used in the fabrication of semiconductor devices. More particularly, the present invention relates to a rinsing and drying apparatus having rotatable nozzles and a method of rinsing and drying semiconductor wafers using the same.

A claim of priority is made to Korean Application No. 2003-99117, the disclosure of which is incorporated herein by reference in its entirety.

2. Discussion of the Related Art

Wet processes such as a wet cleaning process or a wet etching process are used to fabricate semiconductor devices from semiconductor wafers. A rinsing process usually follows a wet process to remove chemical solutions from the wafers, and a drying process follows the rinsing process in order to remove de-ionized water used in the rinsing process. De-ionized water must be completely removed from the wafers during the drying process, if not, “water mark” defects may be formed on the wafers. This defect causes contaminate particles to accumulate on the wafers, thereby causing contact failures in subsequently manufactured semiconductor devices.

Recently, the Marangoni principle has been widely used to maximize drying efficiency in conventional drying processes. One conventional method and apparatus using the Marangoni principle is disclosed in U.S. Pat. No. 5,884,640 to Fishkin et al., entitled “Method and apparatus for drying substrates”. The Fishkin patent discloses draining de-ionized water during a drying process through a valve installed in an outlet of a bath. The valve is controlled by a liquid level control system which requires precise adjustment of the valve to gradually lower liquid level in the bath.

Another conventional apparatus used to dry semiconductor wafers is disclosed in U.S. Pat. No. 5,896,875 to Yoneda, entitled “Equipment for cleaning, etching and drying semiconductor wafer and its using method.” The Yoneda patent discloses, pipe-shaped spray nozzles installed in an upper portion inside a process chamber, and a first rotatable arm provided in a lower portion inside the process chamber. In addition, a pair of second rotatable arms is installed on both ends of the first arm. The second arms have blow-out ports to spray chemical solutions and de-ionized water in an upward direction. Accordingly, a jet stream of cleaning solution and/or de-ionized water is generated inside the process chamber. As a result, the cleaning and/or rinsing efficiency of the process chamber is increased.

However, it is difficult to uniformly inject a drying source such as a drying gas into the process chamber, because the spray nozzles are fixed inside the process chamber. As a result, the overall efficiency of conventional drying processes remains quite limited.

### SUMMARY OF THE INVENTION

According to one aspect of the invention, a rinsing and drying apparatus includes a bath for holding liquid, a conduit installed over the bath, and a plurality of rotatable nozzles attached to the conduit to spray a drying source onto semiconductor wafers.

In another aspect of the invention, a rinsing and drying apparatus includes a bath for holding liquid, a lid covering an upper portion of the bath, a conduit attached to a lower surface of the lid, a plurality of nozzles attached to the conduit to spray a drying source supplied through the conduit, a first power source fixed to the conduit to rotate the nozzles via a belt, and a second power source for swinging the nozzles within a predetermined angle.

The present invention also discloses a method of rinsing semiconductor wafers in a bath using de-ionized water, and spraying through a plurality rotatable nozzles provided over the bath, a drying source towards the rinsed wafers, wherein the plurality of rotatable nozzles are attached to conduit.

### BRIEF DESCRIPTION OF THE DRAWINGS

The above described aspects and advantages of the present invention will become more apparent to those of ordinary skill in the art upon consideration of the following description of preferred embodiments with reference to the attached drawings in which:

FIG. 1 is a side cross-sectional view of a rinsing and drying apparatus according to an embodiment of the present invention;

FIG. 2 is a front cross-sectional view taken along “A” of FIG. 1;

FIG. 3 is a bottom plan view of a lid taken along “B” of FIG. 1; and

FIG. 4 is a process flow chart illustrating a method of rinsing and drying semiconductor wafers of the present invention.

### DETAILED DESCRIPTION OF THE INVENTION

The present invention will now be described more fully with reference to the accompanying drawings in which preferred embodiments of the invention are shown. This invention may, however, be embodied in many different forms and should not be construed as being limited to the embodiments set forth herein. Rather, these embodiments are teaching examples. Like numbers refer to like elements throughout the specification.

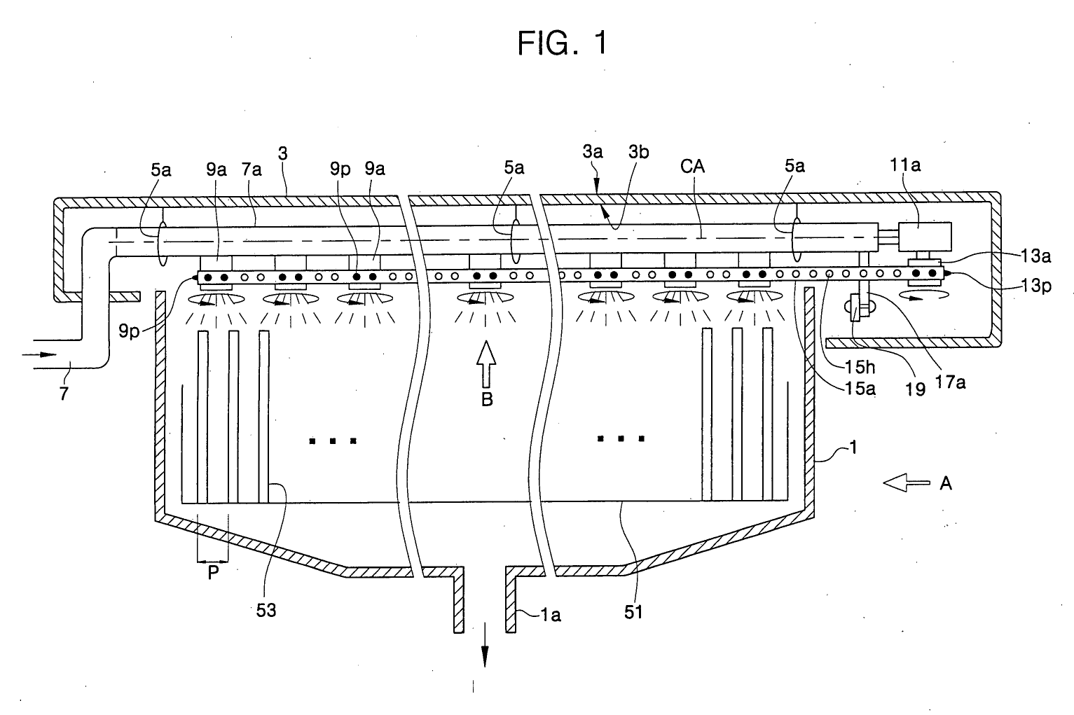

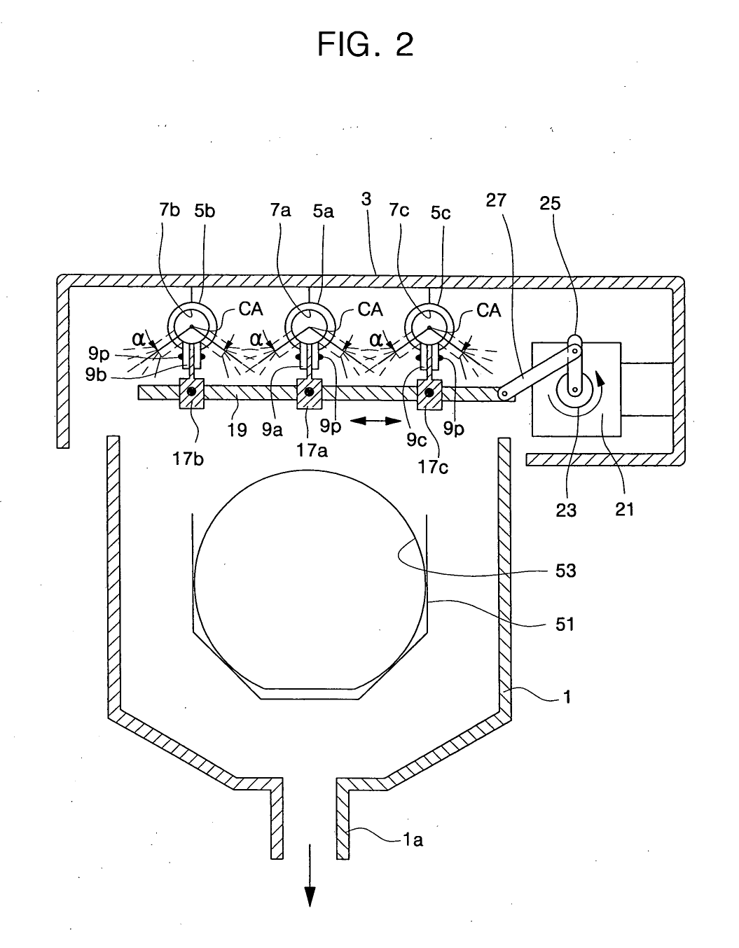

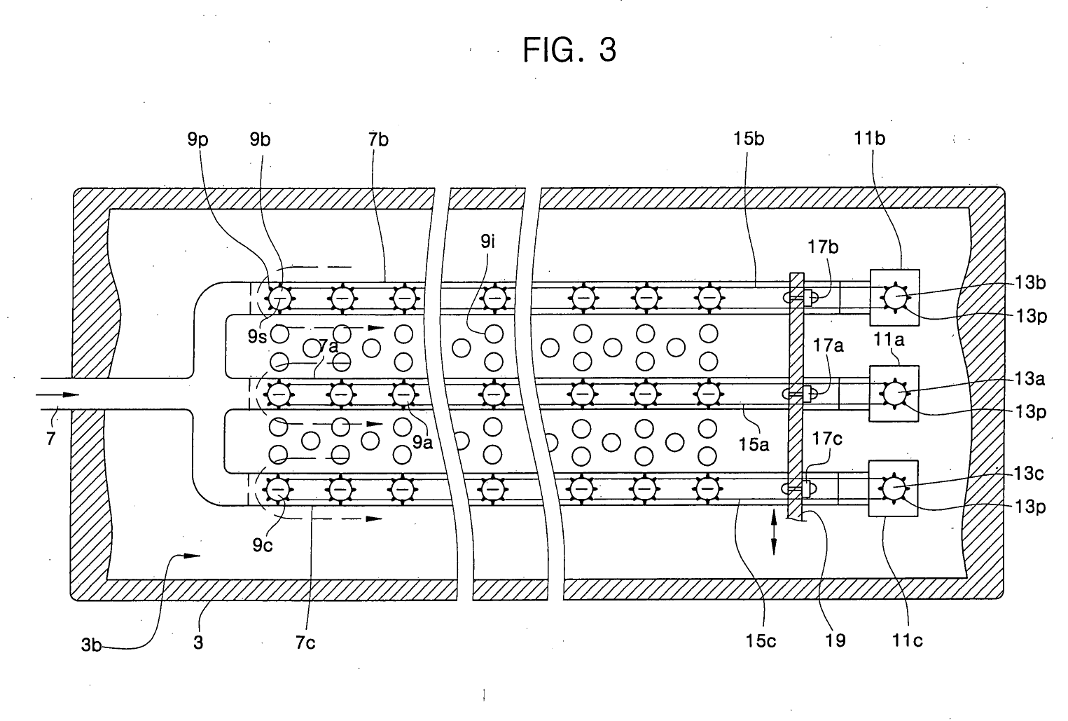

FIG. 1 is a side cross-sectional view of a rinsing and drying apparatus according to an embodiment of the present invention. FIG. 2 is a front cross-sectional view taken along the orientation indicated by arrow “A” in FIG. 1. FIG. 3 is a bottom plan view of a lid taken along the orientation indicated by arrow “B” in FIG. 1.

Collectively, FIGS. 1 through 3 show a bath 1 used to hold liquid such as chemical solution or deionized water. A rinsing process or a drying process is also performed in bath 1. An exhaust conduit 1a is connected to a base of bath 1, and liquid in bath 1 is drained through exhaust conduit 1a. A lid 3 is used to cover bath 1. Lid 3 has an upper surface 3a and a lower surface 3b. A plurality of rings comprising first through third groups of rings 5a, 5b, 5c, respectively, are attached to the lower surface 3b. Each group of rings preferably includes at least two rings. For example, a first group of rings may include three rings 5a aligned in a straight line as shown in FIG. 1. In other words, first group of rings 5a are located in a straight line that traverses above bath 1. A first conduit 7a is inserted into first group of rings 5a.

Further, second group of rings 5b and third group of rings 5c are respectively provided in parallel on both sides of first conduit 7a. Second and third groups of rings 5b, 5c are also attached to the lower surface 3b. A second conduit 7b is inserted into second group of rings 5b, and a third conduit 7c is inserted into third group of rings 5c. Conduits 7a, 7b, 7c are preferably rotatable about their central axes (“CA” of FIGS. 1 and 2). Conduits 7a, 7b, 7c are provided to pass over wafers 53 loaded in bath 1. Wafers 53 are supported by a wafer carrier 51. Conduits 7a, 7b, 7c are drying source conduits, but are not limited to this embodiment. A three conduit system is disclosed in the embodiment of the present invention; however, a single conduit, a pair of conduits, or more than three conduits may be used in the present invention. Conduits 7a, 7b, 7c are connected to a main conduit 7 fixed at one end of lid 3.

A first group of nozzles 9a are attached and evenly arranged along first conduit 7a. Similarly, second and third groups of nozzles 9b, 9c are attached and evenly arranged along second and third conduits 7b, 7c, respectively.

As shown in FIG. 3, each of nozzles 9a, 9b, 9c preferably has a slit-type opening 9s. Nozzles 9a, 9b, 9c are rotatable. In this case, vertical axes passing through a central point of slit-type openings 9s acts as a rotating axis. A drying source introduced into conduits 7a, 7b, 7c is sprayed through slit-type openings 9s of nozzles 9a, 9b, 9c onto wafers 53. Nozzles 9a, 9b, 9c are rotated to uniformly spray a drying source onto wafers 53. In other words, rotating of nozzles 9a, 9b, 9c facilitate the injection of a drying source to uniformly fill gaps between wafers 53. As a result, drying efficiency is improved, and water mark defects can be prevented without increasing a pitch size P between adjacent wafers 53. The drying source may be isopropyl alcohol (IPA) or nitrogen gas, for example. Nitrogen gas may be hot nitrogen gas having a temperature above room temperature.

Further, embodiments of the present invention may optionally include IPA nozzles 9i, which are attached to lower surface 3b of lid 3 between conduits 7a, 7b, 7c. In this case, nozzles 9a, 9b 9c preferably spray a first drying source, such as nitrogen gas, and IPA nozzles 9i preferably spray a second drying source, such as IPA.

Nozzles 9a, 9b, 9c are rotated by a first power source comprising one or more motors. Preferably, nozzles 9a, 9b, 9c are rotated by motors 11a, 1b, 1c, respectively. In this case, motors 11a, 1b, 1c are preferably fixed to one end of conduits 7a, 7b, 7c, respectively. A rotating mechanism associated with motors 11a, 1b, 1c is inserted and fixed to first through third pulleys 13a, 13b, 13c, respectively. The rotating mechanism of motors 11a, 11b, and 11c is adapted to run in parallel with the rotational axes of nozzles 9a, 9b, 9c. Pulleys 13a, 13b, 13c are preferably installed at the same level as nozzles 9a, 9b, 9c.

When motors 11a, 1b, 1c, are in operation, rotational force applied to pulleys 13a, 13b, 13c are transferred to first third belts 15a, 15b, 15c, which in turn rotate nozzles 9a, 9b, 9c. Nozzles 9a, 9b, 9c and pulleys 13a, 13b, 13c have protrusions 9p and 13p, respectively, and belts 15a, 15b, 15c have openings 15h in which protrusions 9p and 13p are inserted to assist in maximizing transfer efficiency of the rotating force supplied by motors 11a, 11b, 11c.

In another embodiment of the present invention, nozzles 9a, 9b, 9c rotate like sprinklers. That is, nozzles 9a, 9b, 9c rotate and spray the drying source without the assistance of a power source. Instead of slit-type opening 9s, each of nozzles 9a, 9b, 9c has at least one sloped opening (not shown) located at an edge of a lower surface. The sloped opening preferably has a predetermined angle with respect to a vertical plane passing through a center of the nozzle. The force of the drying source sprayed through the sloped openings rotates nozzles 9a, 9b, 9c.

In another embodiment of the present invention, conduits 7a, 7b, 7c rotate in an oscillating manner back and forth in clockwise and counterclockwise directions in limited arcs defined by a predetermined angle (“a” of FIG. 2) about their central axes (CA). A second power source 21 is used to oscillate nozzles 9a, 9b, and 9c. Second power source 21 is preferably a motor fixed to lid 3. In this case, second power source 21 preferably includes a rotating mechanism 23. Rotating mechanism 23 is connected to conduits 7a, 7b, 7c through a horizontal bar 19, a buffer bar 27, and an auxiliary bar 25.

In some additional detail, first through third vertical bars 17a, 17b, 17c are attached to conduits 7a, 7b, 7c, respectively. Horizontal bar 19 is connected via pins to an end of vertical bars 17a, 17b, 17c. Horizontal bar 19 is preferably disposed perpendicular to conduits 7a, 7b, 7c. Therefore, when horizontal bar 19 moves left or right along a perpendicular line to conduits 7a, 7b, 7c, nozzles 9a, 9b, 9c oscillate within the predetermined are defined by angle α.

One end of buffer bar 27 is connected to an end of horizontal bar 19 by a pin, and the other end of buffer bar 27 is connected to one end of auxiliary bar 25 by another pin. And the other end of auxiliary bar 25 is fixed to rotating mechanism 23. In this case, when second power source 21 rotates rotating mechanism 23, horizontal bar 19 moves back and forth, and nozzles 9a, 9b, 9c oscillate accordingly. When nozzles 9a, 9b, 9c oscillate by operation of second power source 21, it is preferable that motors 11a, 11b, 11c are respectively fixed to conduits 7a, 7b, 7c to move along accordingly.

As a result, a drying source is uniformly supplied onto wafers 53 with the rotation and oscillation of nozzles 9a, 9b, 9c.

Methods of rinsing and drying semiconductor wafers using the rinsing and drying apparatus shown in FIGS. 1 through 3 will be described.

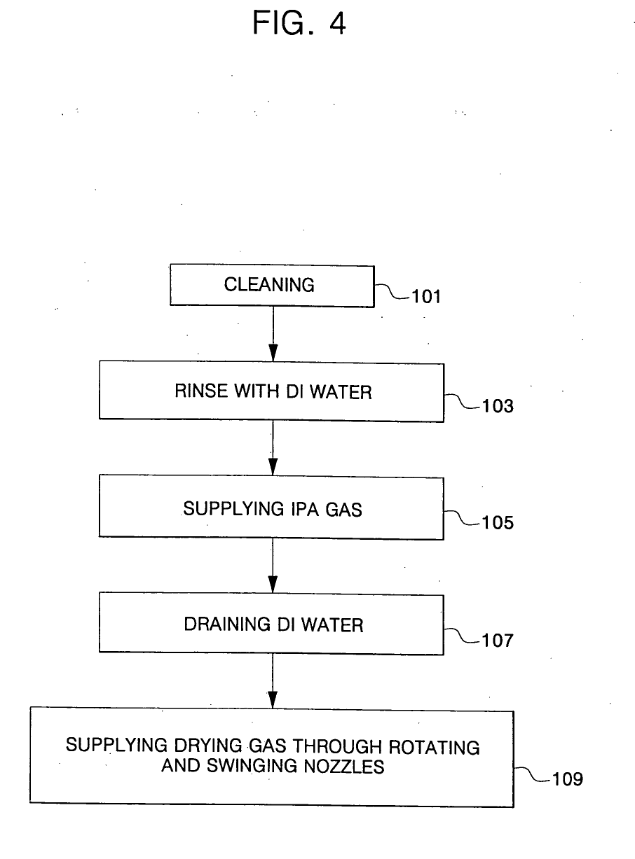

FIG. 4 is a process flow chart illustrating a method of rinsing and drying semiconductor wafers according to an embodiment of the present invention.

Referring to FIGS. 1 through 4, first, semiconductor wafers 53 are cleaned or etched using a chemical solution (step 101). Wafers 53 in a bath 1 are rinsed using de-ionized (DI) water (step 103). The rinsing step is performed using conventional methods. For example, the rinsing process is preferably performed by continuously supplying over-flowing DI water into bath 1. DI water is supplied into bath 1 through a DI water inlet (not shown) connected to bath 1.

Optionally, after the rinsing step, IPA is supplied toward a surface of the DI water through IPA nozzles 9i installed over bath 1 (step 105). As a result, an IPA layer is formed on the surface of the DI water. Subsequently, DI water is slowly drained through an exhaust conduit 1a connected to the base of bath 1 (step 107). Subsequently, DI water is replaced with IPA because IPA has a better surface tension on wafers 53 than DI water.

After draining the DI water, a drying source such as nitrogen gas is supplied onto wafers 53 through nozzles 9a, 9b, 9c (step 109). Nitrogen gas may be hot nitrogen gas heated above room temperature. While the drying source is supplied, it is preferable that nozzles 9a, 9b, 9c are rotated. Nozzles 9a, 9b 9c are rotated by a first power source comprising motors 11a, 11b, 11c. Alternatively, nozzles 9a, 9b, 9c may rotate in a sprinkler manner without a power source.

Furthermore, a second power source 21 preferably oscillates nozzles 9a, 9b, 9c. As a result, the drying source is uniformly supplied onto wafers 53 through the rotation and oscillation of nozzles 9a, 9b, 9c, thereby preventing the formation of defects such as water marks on wafers 53.

As described above, according to the present invention, a drying source can be uniformly sprayed onto wafers through the rotation and oscillation of nozzles. Therefore, the drying efficiency of semiconductor wafers rinsed in the bath can be significantly improved.

1. A rinsing and drying apparatus comprising:
a bath for holding liquid;
at least one conduit installed over the bath; and
a plurality of rotatable nozzles attached to the at least one conduit and adapted to spray a drying source.

2. The apparatus of claim 1, wherein the bath is adapted to perform a rinsing process or a drying process therein.

3. The apparatus of claim 1, wherein the at least one conduit comprises a plurality of conduits arranged in parallel with each other.

4. The apparatus of claim 3, further comprising a main conduit connected to the plurality of conduits.

5. The apparatus of claim 1, wherein each of the plurality of rotatable nozzles has a slit-type opening, and rotational axes of the nozzles are vertical axes passing through central points in the slit-type openings.

6. The apparatus of claim 1, wherein the drying source is isopropyl alcohol or nitrogen gas.

7. The apparatus of claim 6, wherein the nitrogen gas is hot nitrogen gas having a temperature above room temperature.

8. The apparatus of claim 1, wherein the plurality of rotatable nozzles are rotated by a motor.

9. The apparatus of claim 8, wherein each of the plurality of rotatable nozzles has a plurality of protrusions, and wherein the motor rotates the plurality of rotatable nozzles by a belt, the belt having openings into which the plurality of protrusions are inserted.

10. The apparatus of claim 8, wherein the motor is fixed to one of the at least one conduit.

11. The apparatus of claim 1, further comprising a lid covering an upper portion of the bath, wherein the at least one conduit is attached to a lower surface of the lid.

12. The apparatus of claim 1, further comprising a second plurality of rotatable nozzles installed over the bath to only supply isopropyl alcohol.

13. A rinsing and drying apparatus comprising:
a bath for holding liquid;
a lid covering an upper portion of the bath;
at least one conduit attached to a lower surface of the lid;
a plurality of rotatable nozzles attached to the conduit to spray a drying source supplied through the at least one conduit;
a first power source fixed to the at least one conduit to rotate the nozzles via a belt; and
a second power source for oscillating the nozzles within a predetermined arc.

14. The apparatus of claim 13, further comprising a main conduit connected to the at least one conduit.

15. The apparatus of claim 13, wherein each of the plurality of rotatable nozzles has a slit-type opening, and rotational axes of the nozzles are vertical axes passing through central points in the slit-type openings.

16. The apparatus of claim 13, wherein the drying source is isopropyl alcohol or nitrogen gas.

17. The apparatus of claim 13, wherein the first power source is a motor.

18. The apparatus of claim 13, wherein each of the plurality of rotatable nozzles has a plurality of protrusions, and the belt has holes into which the protrusions are inserted.

19. The apparatus of claim 13, wherein the second power source is a motor fixed to the lid.

20. The apparatus of claim 19, further comprising:
a vertical bar fixed to the at least one conduit; and
a horizontal bar connected to an end of the vertical bar via a pin and disposed to be perpendicular to the conduit, wherein the second power source moves the horizontal bar along a direction crossing the conduit to oscillate the nozzles.

21. The apparatus of claim 13, further comprising a plurality of rings surrounding the at least one conduit, wherein the rings are fixed to the lid to support the at least one conduit.

22. A method of rinsing and drying semiconductor wafers, comprising:
rinsing the semiconductor wafers in a bath using de-ionized water; and
spraying through a plurality rotatable nozzles provided over the bath, a drying source towards the rinsed wafers, wherein the plurality of rotatable nozzles are attached to at least one conduit.

23. The method of claim 22, further comprising cleaning the semiconductor wafers in the bath prior to rinsing the semiconductor wafers.

24. The method of claim 22, wherein each of the plurality of rotatable nozzles has a slit-type opening, and the plurality of rotatable nozzles are rotated using belts connected to a motor.

25. The method of claim 22, further comprising oscillating the plurality of rotatable nozzles while rotating the plurality of rotatable nozzles.

26. The method of claim 25, wherein oscillating of the plurality of rotatable nozzles comprises rotating the at least one conduit to which the plurality of rotatable nozzles are attached alternately in clockwise and counterclockwise directions within a predetermined arc.

27. The method of claim 22, wherein the drying source is nitrogen gas.

28. The method of claim 27, further comprising supplying isopropyl alcohol into the bath through a second plurality of nozzles installed over the bath before supplying the drying source.
